(19) United States
(12) Patent Application Publication
(10) Pub. No.: US 2005/0088458 A1
(43) Pub. Date: Apr. 28, 2005

(54) Unified surface model for image based and geometric scene composition

(76) Inventors: Christopher F. Marrin, Menlo Park, CA (US); James R. Kent, Gahanna, OH (US); Robert K. Myers, Santa Cruz, CA (US); Peter G. Broadwell, Palo Alto, CA (US)

Correspondence Address: Richard H. Butler;#106, 5655 Silver Creek Valley Road, San Jose, CA, 95138, US

(21) Appl. No.: 10/990,855

(22) Filed: Nov. 16, 2004

Related U.S. Application Data
(63) Continuation of application No. 10/632,350, filed on Jul. 31, 2003.

(51) Int. Cl. G06T 15/00

(52) U.S. Cl. 345/629

(57) ABSTRACT

A system and method for the real-time composition and presentation of a complex, dynamic, and interactive experience by means of an efficient declarative markup language. Using the Surface construct, authors can embed images or full-motion video data anywhere they would use a traditional texture map within their 3D scene. Authors can also use the results of rendering one scene description as an image to be texture mapped into another scene. In particular, the Surface allows the results of any rendering application to be used as a texture within the author's scene. This allows declarative rendering of nested scenes and rendering of scenes having component Surfaces with decoupled rendering rates.

### RELATED APPLICATION

The present application claims priority from provisional patent application Ser. No. 60/147,092, filed on Aug. 3, 1999, now pending.

### FIELD OF THE INVENTION

This invention relates generally to a modeling language for 3D graphics and, more particularly, to embedding images in a scene.

### BACKGROUND OF THE INVENTION

In computer graphics, traditional real-time 3D scene rendering is based on the evaluation of a description of the scene's 3D geometry, resulting in the production of an image presentation on a computer display. Virtual Reality Modeling Language (VRML hereafter) is a conventional modeling language that defines most of the commonly used semantics found in conventional 3D applications such as hierarchical transformations, light sources, view points, geometry, animation, fog, material properties, and texture mapping. Texture mapping processes are commonly used to apply externally supplied image data to a given geometry within the scene. For example VRML allows one to apply externally supplied image data, externally supplied video data or externally supplied pixel data to a surface. However, VRML does not allow the use of rendered scene as an image to be texture mapped declaratively into another scene. In a declarative markup language, the semantics required to attain the desired outcome are implicit, and therefore a description of the outcome is sufficient to get the desired outcome. Thus, it is not necessary to provide a procedure (i.e., write a script) to get the desired outcome. As a result, it is desirable to be able to compose a scene using declarations. One example of a declarative language is the Hypertext Markup Language (HTML).

Further, it is desirable to declaratively combine any two surfaces on which image data was applied to produce a third surface. It is also desirable to declaratively re-render the image data applied to a surface to reflect the current state of the image.

Traditionally, 3D scenes are rendered monolithically, producing a final frame rate to the viewer that is governed by the worst-case performance determined by scene complexity or texture swapping. However, if different rendering rates were used for different elements on the same screen, the quality would improve and viewing experience would be more television-like and not a web-page-like viewing experience.

### SUMMARY OF THE INVENTION

A system and method for the real-time composition and presentation of a complex, dynamic, and interactive experience by means of an efficient declarative markup language. Using the Surface construct, authors can embed images or full-motion video data anywhere they would use a traditional texture map within their 3D scene. Authors can also use the results of rendering one scene description as an image to be texture mapped into another scene. In particular, the Surface allows the results of any rendering application to be used as a texture within the author's scene. This allows declarative rendering of nested scenes and rendering of scenes having component Surfaces with decoupled rendering rates

### BRIEF DESCRIPTION OF THE DRAWINGS

FIG. 1A shows the basic architecture of Blendo.

FIG. 1B is a flow diagram illustrating flow of content through Blendo engine.

FIG. 2A illustrates how two surfaces in a scene arc rendered at different rendering rates.

FIG. 2B is a flow chart illustrating acts involved in rendering the two surfaces shown in FIG. 2A at different rendering rates.

FIG. 3A illustrates a nested scene.

FIG. 3B is a flow chart showing acts performed to render the nested scene of FIG. 3A.

### DETAILED DESCRIPTION

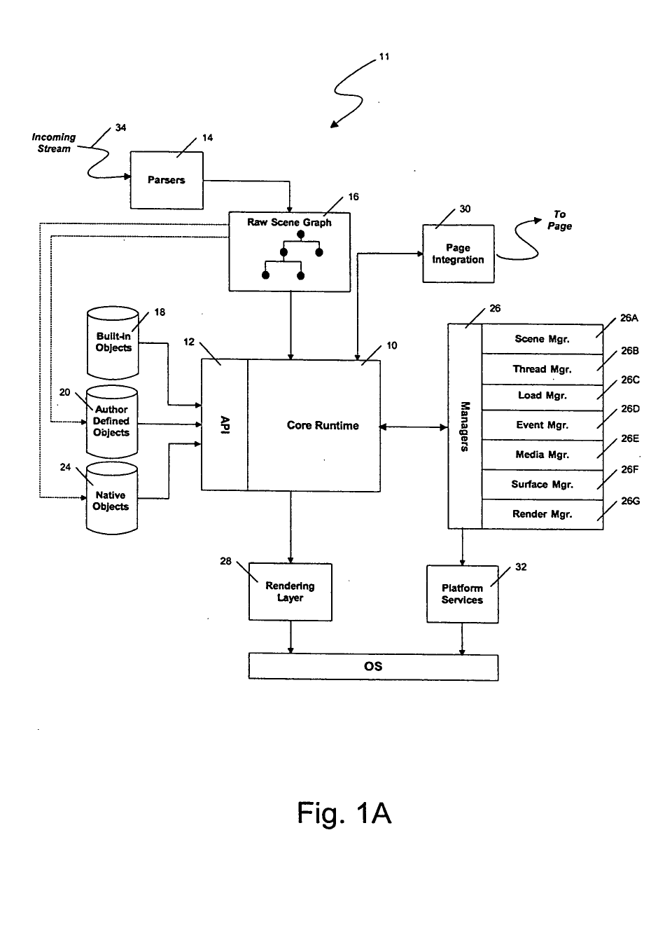

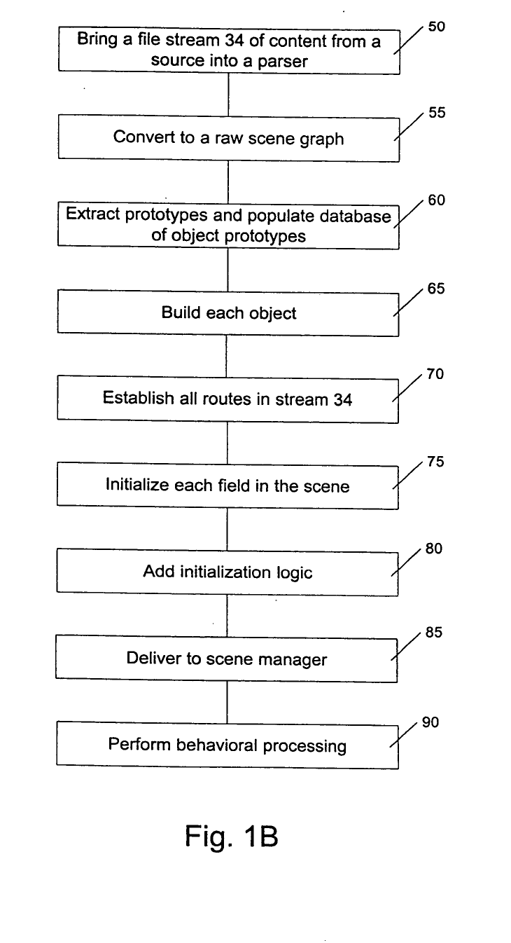

Blendo is an exemplary embodiment of the present invention that allows temporal manipulation of media assets including control of animation and visible imagery, and cueing of audio media, video media, animation and event data to a media asset that is being played. FIG. 1A shows basic Blendo architecture. A comprehensive description of Blendo can be found in Appendix A. At the core of the Blendo architecture is a Core Runtime module 10 (Core hereafter) which presents various Application Programmer Interface (API hereafter) elements and the object model to a set of objects present in system 11. During normal operation, a file is parsed by parser 14 into a raw scene graph 16 and passed on to Core 10, where its objects are instantiated and a runtime scene graph is built. The objects can be built-in objects 18, author defined objects 20, native objects 24, or the like. The objects use a set of available managers 26 to obtain platform services 32. These platform services 32 include event handling, loading of assets, playing of media, and the like. The objects use rendering layer 28 to compose intermediate or final images for display. A page integration component 30 is used to interface Blendo to an external environment, such as an HTML or XML page.

Blendo contains a system object with references to the set of managers 26. Each manager 26 provides the set of APIs to control some aspect of system 11. An event manager 26D provides access to incoming system events originated by user input or environmental events. A load manager 26C facilitates the loading of Blendo files and native node implementations. A media manager 26E provides the ability to load, control and play audio, image and video media assets. A render manager 26G allows the creation and management of objects used to render scenes. A scene manager 26A controls the scene graph. A surface manager 26F allows the creation and management of surfaces onto which scene elements and other assets may be composited. A thread manager 26B gives authors the ability to spawn and control threads and to communicate between them.

FIG. 1B illustrates in a flow diagram, a conceptual description of the flow of content through a Blendo engine. In block 50, a presentation begins with a source which includes a file or stream 34 (FIG. 1A) of content being brought into parser 14 (FIG. 1A). The source could be in a native VRML-like textual format, a native binary format, an XML based format, or the like. Regardless of the format of the source, in block 55, the source is converted into raw scene graph 16 (FIG. 1A). The raw scene graph 16 can represent the nodes, fields and other objects in the content, as well as field initialization values. It also can contain a description of object prototypes, external prototype references in the stream 34, and route statements.

The top level of raw scene graph 16 include nodes, top level fields and functions, prototypes and routes contained in the file. Blendo allows fields and functions at the top level in addition to traditional elements. These are used to provide an interface to an external environment, such as an HTML page. They also provide the object interface when a stream 34 is used as the contents of an external prototype.

Each raw node includes a list of the fields initialized within its context. Each raw field entry includes the name, type (if given) and data value(s) for that field. Each data value includes a number, a string, a raw node, and/or a raw field that can represent an explicitly typed field value.

In block 60, the prototypes are extracted from the top level of raw scene graph 16 (FIG. 1A) and used to populate the database of object prototypes accessible by this scene.

The raw scene graph 16 is then sent through a build traversal. During this traversal, each object is built (block 65), using the database of object prototypes.

In block 70, the routes in stream 34 are established. Subsequently, in block 75, each field in the scene is initialized. This is done by sending initial events to non-default fields of Objects. Since the scene graph structure is achieved through the use of node fields, block 75 also constructs the scene hierarchy as well. Events are fired using in order traversal. The first node encountered enumerates fields in the node. If a field is a node, that node is traversed first.

As a result the nodes in that particular branch of the tree are initialized. Then, an event is sent to that node field with the initial value for the node field.

After a given node has had its fields initialized, the author is allowed to add initialization logic (block 80) to prototyped objects to ensure that the node is fully initialized at call time. The blocks described above produce a root scene. In block 85 the scene is delivered to the scene manager 26A (FIG. 1A) created for the scene. In block 90, the scene manager 26A is used to render and perform behavioral processing either implicitly or under author control.

A scene rendered by the scene manager 26A can be constructed using objects from the Blendo object hierarchy. Appendix B shows the object hierarchy and provides a detailed description of the objects in Blendo. Objects may derive some of their functionality from their parent objects, and subsequently extend or modify their functionality. At the base of the hierarchy is the Object. The two main classes of objects derived from the Object are a Node and a Field. Nodes contain, among other things, a render method, which gets called as part of the render traversal. The data properties of nodes are called fields. Among the Blendo object hierarchy is a class of objects called Timing Objects, which are described in detail below. The following code portions are for exemplary purposes. It should be noted that the line numbers in each code portion merely represent the line numbers for that particular code portion and do not represent the line numbers in the original source code.

Surface Objects

A Surface Object is a node of type SurfaceNode. A SurfaceNode class is the base class for all objects that describe a 2D image as an array of color, depth and opacity (alpha) values. SurfaceNodes are used primarily to provide an image to be used as a texture map. Derived from the SurfaceNode Class are MovieSurface, ImageSurface, MatteSurface, PixelSurface and SceneSurface. It should be noted the the line numbers in each code portion merely represent the line numbers for that code portion and do not represent the line numbers in the original source code.

MovieSurface

The following code portion illustrates the MovieSurface node. A description of each field in the node follows thereafter.

| | |
|---|---|
| 1) | MovieSurface : SurfaceNode TimedNode AudioSourceNode { |
| 2) | field MF String url [ ] |
| 3) | field TimeBaseNode timeBase NULL |
| 4) | field Time duration 0 |
| 5) | field Time loadTime 0 |
| 6) | field String loadStatus “NONE” |
| | } |

A MovieSurface node renders a movie on a surface by providing access to the sequence of images defining the movie. The MovieSurface's TimedNode parent class determines which frame is rendered onto the surface at any one time. Movies can also be used as sources of audio.

In line 2 of the code portion, (“Multiple Value Field) the URL field provides a list of potential locations of the movie data for the surface. The list is ordered such that element 0 describes the preferred source of the data. If for any reason element 0 is unavailable, or in an unsupported format, the next element may be used.

In line 3, the timeBase field, if specified, specifies the node that is to provide the timing information for the movie. In particular, the timeBase will provide the movie with the information needed to determine which frame of the movie to display on the surface at any given instant. If no timeBase is specified, the surface will display the first frame of the movie.

In line 4, the duration field is set by the MovieSurface node to the length of the movie in seconds once the movie data has been fetched.

In line 5 and 6, the loadTime and the loadStatus fields provide information from the MovieSurface node concerning the availability of the movie data. LoadStatus has five possible values, “NONE”, “REQUESTED”, “FAILED”, “ABORTED”, and “LOADED”.

“NONE” is the initial state. A “NONE” event is also sent if the node's url is cleared by either setting the number of values to 0 or setting the first URL string to the empty string. When this occurs, the pixels of the surface are set to black and opaque (i.e. color is 0,0,0 and transparency is 0).

A “REQUESTED” event is sent whenever a non-empty url value is set. The pixels of the surface remain unchanged after a “REQUESTED” event.

“FAILED” is sent after a “REQUESTED” event if the movie loading did not succeed. This can happen, for example, if the URL refers to a non-existent file or if the file does not contain valid data. The pixels of the surface remain unchanged after a “FAILED” event.

An “ABORTED” event is sent if the current state is “REQUESTED” and then the URL changes again. If the URL is changed to a non-empty value, “ABORTED” is followed by a “REQUESTED” event. If the URL is changed to an empty value, “ABORTED” is followed by a “NONE” value. The pixels of the surface remain unchanged after an “ABORTED” event.

A “LOADED” event is sent when the movie is ready to be displayed. It is followed by a loadTime event whose value matches the current time. The frame of the movie indicated by the timeBase field is rendered onto the surface. If timeBase is NULL, the first frame of the movie is rendered onto the surface.

ImageSurface

The following code portion illustrates the ImageSurface node. A description of each field in the node follows thereafter.

| 1) | ImageSurface : SurfaceNode { | | |
|---|---|---|---|
| 2) | field MF String | url | [ ] |
| 3) | field Time | loadTime | 0 |
| 4) | field String | loadStatus | “NONE” |
| | } | | |

An ImageSurface node renders an image file onto a surface. In line 2 of the code portion, the URL field provides a list of potential locations of the image data for the surface. The list is ordered such that element 0 describes the most preferred source of the data. If for any reason element 0 is unavailable, or in an unsupported format, the next element may be used.

In line 3 and 4, the loadTime and the loadStatus fields provide information from the ImageSurface node concerning the availability of the image data. LoadStatus has five possible values, “NONE”, “REQUESTED”, “FAILED”, “ABORTED”, and “LOADED”.

“NONE” is the initial state. A “NONE” event is also sent if the node's URL is cleared by either setting the number of values to 0 or setting the first URL string to the empty string. When this occurs, the pixels of the surface are set to black and opaque (i.e. color is 0,0,0 and transparency is 0).

A “REQUESTED” event is sent whenever a non-empty URL value is set. The pixels of the surface remain unchanged after a “REQUESTED” event.

“FAILED” is sent after a “REQUESTED” event if the image loading did not succeed. This can happen, for example, if the URL refers to a non-existent file or if the file does not contain valid data. The pixels of the surface remain unchanged after a “FAILED” event.

An “ABORTED” event is sent if the current state is “REQUESTED” and then the URL changes again. If the URL is changed to a non-empty value, “ABORTED” will be followed by a “REQUESTED” event. If the URL is changed to an empty value, “ABORTED” will be followed by a “NONE” value. The pixels of the surface remain unchanged after an “ABORTED” event.

A “LOADED” event is sent when the image has been rendered onto the surface. It is followed by a loadTime event whose value matches the current time.

MatteSurface

The following code portion illustrates the MatteSurface node. A description of each field in the node follows thereafter.

| | |
|---|---|
| 1) | MatteSurface : SurfaceNode { |
| 2) | field SurfaceNode surface1 NULL |
| 3) | field SurfaceNode surface2 NULL |
| 4) | field String operation “ ” |
| 5) | field MF Float parameter 0 |
| 6) | field Bool overwriteSurface2 FALSE |
| | } |

The MatteSurface node uses image compositing operations to combine the image data from surface1 and surface2 onto a third surface. The result of the compositing operation is computed at the resolution of surface2. If the size of surface1 differs from that of surface2, the image data on surface1 is zoomed up or down before performing the operation to make the size of surface1 equal to the size of surface2.

In lines 2 and 3 of the code portion, the surface1 and surface2 fields specify the two surfaces that provide the input image data for the compositing operation. In line 4, the operation field specifies the compositing function to perform on the two input surfaces. Possible operations are described below.

“REPLACE_ALPHA” overwrites the alpha channel A of surface2 with data from surface1. If surface1 has 1 component (grayscale intensity only), that component is used as the alpha (opacity) values. If surface1 has 2 or 4 components (grayscale intensity+alpha or RGBA), the alpha channel A is used to provide the alpha values. If surface1 has 3 components (RGB), the operation is undefined. This operation can be used to provide static or dynamic alpha masks for static or dynamic images. For example, a SceneSurface could render an animated James Bond character against a transparent background. The alpha component of this image could then be used as a mask shape for a video clip.

“MULTIPLY_ALPHA” is similar to REPLACE_ALPHA, except the alpha values from surface1 are multiplied with the alpha values from surface2.

“CROSS_FADE” fades between two surfaces using a parameter value to control the percentage of each surface that is visible. This operation can dynamically fade between two static or dynamic images. By animating the parameter value (line 5) from 0 to 1, the image on surface1 fades into that of surface2.

“BLEND” combines the image data from surface1 and surface2 using the alpha channel from surface2 to control the blending percentage. This operation allows the alpha channel of surface2 to control the blending of the two images. By animating the alpha channel of surface2 by rendering a SceneSurface or playing a MovieSurface, you can produce a complex travelling matte effect. If R1, G1, B1, and A1 represent the red, green, blue, and alpha values of a pixel of surface1 and R2, G2, B2, and A2 represent the red, green, blue, and alpha values of the corresponding pixel of surface2, then the resulting values of the red, green, blue, and alpha components of that pixel are:
red=R1*(1−A2)+R2*A2 (1)
green=G1*(1−A2)+G2*A2 (2)
blue=B1*(1−A2)+B2*A2 (3)
alpha=1 (4)

“ADD”, and “SUBTRACT” add or subtract the color channels of surface1 and surface2. The alpha of the result equals the alpha of surface2.

In line 5, the parameter field provides one or more floating point parameters that can alter the effect of the compositing function. The specific interpretation of the parameter values depends upon which operation is specified.

In line 6, the overwriteSurface2 field indicates whether the MatteSurface node should allocate a new surface for storing the result of the compositing operation (overwriteSurface2=FALSE) or whether the data stored on surface2 should be overwritten by the compositing operation (overwriteSurface2=TRUE).

PixelSurface

The following code portion illustrates the SceneSurface node. A description of the field in the node follows thereafter.

| | |
|---|---|
| 1) | PixelSurface : SurfaceNode { |
| 2) | field Image image 0 0 0 |
| | } |

A PixelSurface node renders an array of user-specified pixels onto a surface. In line 2, the image field describes the pixel data that is rendered onto the surface.

SceneSurface

The following code portion illustrates the use of SceneSurface node. A description of each field in the node follows thereafter.

| | |
|---|---|
| 1) | SceneSurface : SurfaceNode { |
| 2) | field MF ChildNode children [ ] |
| 3) | field UInt32 width 1 |
| 4) | field UInt32 height 1 |
| | } |

A SceneSurface node renders the specified children on a surface of the specified size. The SceneSurface automatically re-renders itself to reflect the current state of its children.

In line 2 of the code portion, the children field describes the ChildNodes to be rendered. Conceptually, the children field describes an entire scene graph that is rendered independently of the scene graph that contains the SceneSurface node.

In lines 3 and 4, the width and height fields specify the size of the surface in pixels. For example, if width is 256 and height is 512, the surface contains a 256×512 array of pixel values.

The MovieSurface, ImageSurface, MatteSurface, PixelSurface & SceneSurface nodes are utilized in rendering a scene.

At the top level of the scene description, the output is mapped onto the display, the “top level Surface.” Instead of rendering its results to the display, the 3D rendered scene can generate its output onto a Surface using one of the above mentioned SurfaceNodes, where the output is available to be incorporated into a richer scene composition as desired by the author. The contents of the Surface, generated by rendering the surface's embedded scene description, can include color information, transparency (alpha channel) and depth, as part of the Surface's structured image organization. An image, in this context is defined to include a video image, a still image, an animation or a scene.

A Surface is also defined to support the specialized requirements of various texture-mapping systems internally, behind a common image management interface. As a result, any Surface producer in the system can be consumed as a texture by the 3D rendering process. Examples of such Surface producers include an Image Surface, a MovieSurface, a MatteSurface, a SceneSurface, and an ApplicationSurface.

An ApplicationSurface maintains image data as rendered by its embedded application process, such as a spreadsheet or word processor, a manner analogous to the application window in a traditional windowing system.

The integration of surface model with rendering production and texture consumption allows declarative authoring of decoupled rendering rates. Traditionally, 3D scenes have been rendered monolithically, producing a final frame rate to the viewer that is governed by the worst-case performance due to scene complexity and texture swapping. In a real-time, continuous composition framework, the Surface abstraction provides a mechanism for decoupling rendering rates for different elements on the same screen. For example, it may be acceptable to portray a web browser that renders slowly, at perhaps 1 frame per second, but only as long as the video frame rate produced by another application and displayed alongside the output of the browser can be sustained at a full 30 frames per second. If the web browsing application draws into its own Surface, then the screen compositor can render unimpeded at full motion video frame rates, consuming the last fully drawn image from the web browser's Surface as part of its fast screen updates.

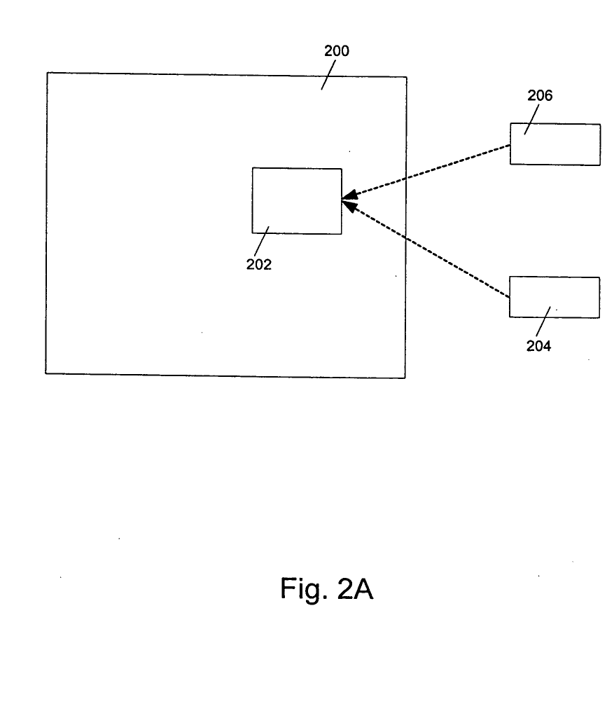

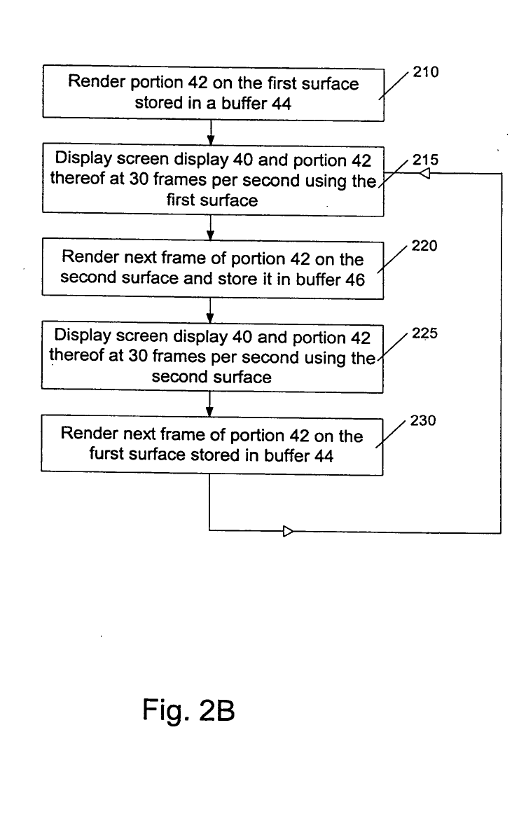

FIG. 2A illustrates a scheme for rendering a complex portion 202 of screen display 200 at full motion video frame rate. FIG. 2B is a flow diagram illustrating various acts included in rendering screen display 200 including complex portion 202 at full motion video rate. It may be desirable for a screen display 200 to be displayed at 30 frames per second, but a portion 202 of screen display 200 may be too complex to display at 30 frames per second. In this case, portion 202 is rendered on a first surface and stored in a buffer 204 as shown in block 210 (FIG. 2B). In block 215, screen display 200 including portion 202 is displayed at 30 frames per second by using the first surface stored in buffer 204. While screen display 200, including portion 200, is being displayed, the next frame of portion 202 is rendered on a second surface and stored in buffer 206 as shown in block 220. Once this next frame of portion 202 is available, the next update of screen display 200 uses the second surface (block 225) and continues to do so till a further updated version of portion 202 is available in buffer 204. While the screen display 200 is being displayed using the second surface, the next frame of portion 202 is being rendered on first surface as shown in block 230. When the rendering of the next frame on the first surface is complete, the updated first surface will be used to display screen display 200 including complex portion 202 at 30 frames per second.

The integration of surface model with rendering production and texture consumption allows nested scenes to be rendered declaratively. Recomposition of subscenes rendered as images enables open-ended authoring. In particular, the use of animated sub-scenes, which are then image-blended into a larger video context, enables a more relevant aesthetic for entertainment computer graphics. For example, the image blending approach provides visual artists with alternatives to the crude hard-edged clipping of previous generations of windowing systems.

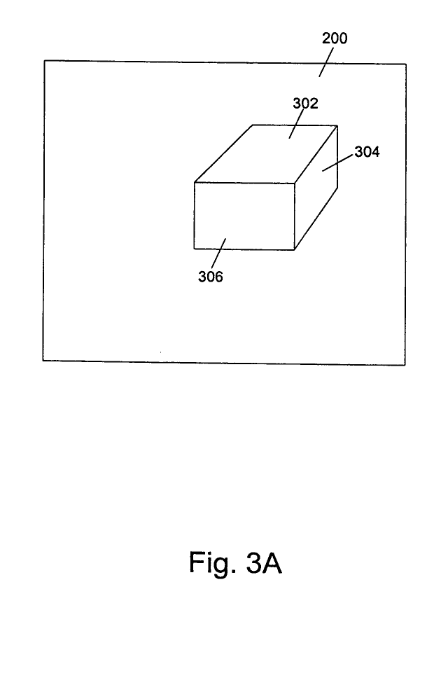

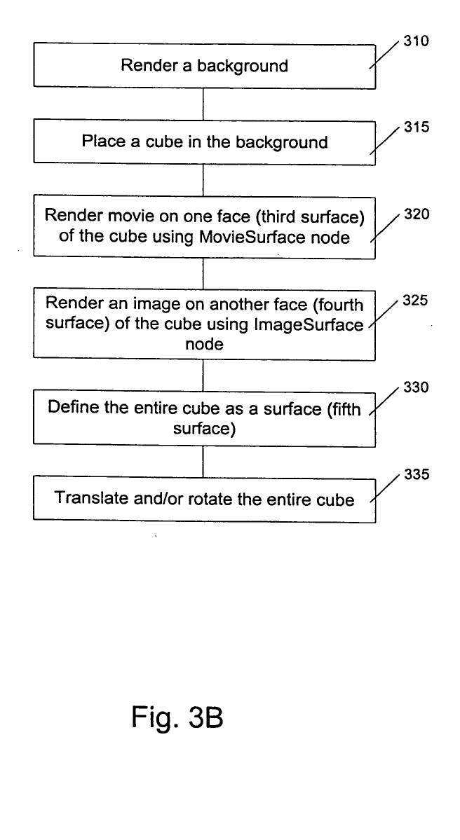

FIG. 3A depicts a nested scene including an animated sub-scene. FIG. 3B is a flow diagram showing acts performed to render the nested scene of FIG. 3A. Block 310 renders a background image displayed on screen display 200, and block 315 places a cube 302 within the background image displayed on screen display 200. The area outside of cube 302 is part of a surface that forms the background for cube 302 on display 200. A face 304 of cube 302 is defined as a third surface. Block 320 renders a movie on the third surface using a MovieSurface node. Thus, face 304 of the cube displays a movie that is rendered on the third surface. Face 306 of cube 302 is defined as a fourth surface. Block 325 renders an image on the fourth surface using an ImageSurface node. Thus, face 306 of the cube displays an image that is rendered on the fourth surface. In block 330, the entire cube 302 is defined as a fifth surface and in block 335 this fifth surface is translated and/or rotated thereby creating a moving cube 52 with a movie playing on face 304 and a static image displayed on face 306. A different rendering can be displayed on each face of cube 302 by following the procedure described above. It should be noted that blocks 310 to 335 can be done in any sequence including starting all the blocks 310 to 335 at the same time.

It is to be understood that the present invention is independent of Blendo, and it can be part of an embodiment separate from Blendo. It is also to be understood that while the description of the invention describes 3D scene rendering, the invention is equally applicable to 2D scene rendering. The surface model enables authors to freely intermix image and video effects with 2D and 3D geometric mapping and animation.

While particular embodiments of the present invention have been shown and described it will be apparent to those skilled in the art that changes and modifications may be made without departing from this invention in its broader aspect and, therefore, the appended claims are to encompass within their scope all such changes and modifications as fall within the true sprit and scope of this invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A computer system, comprising a computer and a computer program executed by the computer, wherein the computer program comprises computer instructions for:
rendering a first scene at a first rendering rate;
rendering a second scene at a second rendering rate;
wherein the second scene forms a sub-scene within the first scene and the first rendering rate is decoupled from the second rendering rate.

18. The computer system of claim 17, wherein the first scene and the second scene are rendered based on declarative instructions.

19. The computer system of claim 17, wherein a first rendering of the second scene is stored in a first buffer and a second rendering of the second scene is stored in a second buffer, and the first rendering and the second rendering are updated continually, one rendering being updated at a time.

20. The computer system of claim 19, wherein the sub-scene is refreshed using the latest rendering chosen from a group consisting of the first rendering and the second rendering.

21. The computer system of claim 20, wherein the first rendering rate is equal to the second rendering rate.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A method of displaying a scene using a computer, the method comprising:
rendering a first scene at a first rendering rate; and
rendering a second scene at a second rendering rate, wherein the second scene forms a sub-scene within the first scene and the first rendering rate is decoupled from the second rendering rate.

37. The method of claim 36, further comprising:
providing declarative instructions to render the first scene and the second scene.

38. The method of claim 36, further comprising:
storing a first rendering of the second scene in a first bugger and a second rendering of the second scene in a second buffer; and
continually updating, one rendering at a time, the first rendering and the second rendering.

39. The method of claim 36, further comprising:
rendering the sub-scene using the latest rendering chosen from the group consisting of the first rendering and the second rendering.

40. The method of claim 36, wherein the first rendering rate is different from the second rendering rate.

41. A method comprising:
rendering an object;
declaratively rendering a scene on a surface of the object; and
moving the object while rendering the scene wherein the scene is declaratively rendered based on a location of the surface, wherein the scene is produced through a declarative markup language.

42. The method according to claim 41 wherein moving the object further comprises rotating the object through a three dimensional space.

43. The method according to claim 42 further comprising automatically modifying the surface based rotating the object through the three dimensional space.

44. The method according to claim 43 further comprising updating the scene based on modifying the surface.

45. The method according to claim 41 wherein the object is a cube.

46. The method according to claim 41 wherein the surface is one side of a cube.

47. The method according to claim 41 wherein the surface is a flat two dimensional surface.

48. The method according to claim 41 wherein the surface is a curved three dimensional surface.

49. The method according to claim 41 wherein the scene is a series of animated images.

50. The method according to claim 41 wherein the scene is a static image.

51. A method comprising:
rendering an object;
declaratively rendering a scene on a surface of the object; and
bending the object while rendering the scene wherein the scene is declaratively rendered based on a location of the surface, wherein the scene is produced through a declarative markup language.

52. The method according to claim 51 further comprising modifying the surface based on bending the object.

53. The method according to claim 52 further comprising updating the scene based on modifying the surface.

54. A computer system, comprising a computer and a computer program executed by the computer, wherein the computer program comprises computer instructions for:
rendering an object;
declaratively rendering a scene on a surface of the object; and
moving the object while rendering the scene wherein the scene is declaratively rendered based on a location of the surface, wherein the scene is produced through a declarative markup language.

55. A system comprising:
means for rendering an object;
means for declaratively rendering a scene on a surface of the object; and
moving the object while rendering the scene wherein the scene is declaratively rendered based on a location of the surface, wherein the scene is produced through a declarative markup language.

56. A method comprising:
rendering an object with a surface;
declaratively rendering a scene on the surface
moving the surface through a three dimensional space;
updating the scene based on a current location of the surface in the three dimensional space.

57. The method according to claim 56 wherein the scene is produced through a declarative markup language.

58. The method according to claim 56 further comprising rotating the object.

59. The method according to claim 56 wherein updating the scene further comprises modifying a size of the scene when a size of the surface changes.

60. The method according to claim 56 wherein updating the scene further comprises modifying a perspective of the scene when a perspective of the surface changes.

61. The method according to claim 56 wherein the scene is a series of animated images.

62. The method according to claim 56 wherein the scene is a static image.
